(19) United States
(12) Patent Application Publication
(10) Pub. No.: US 2018/0035657 A1
(43) Pub. Date: Feb. 8, 2018

(54) PEST CONTROL SYSTEM

(71) Applicant: Creative Pest Design Inc., Burlington (CA)

(72) Inventors: Kirk Ots, Ajax (CA); Dean Stanbridge, Burlington (CA)

(21) Appl. No.: 15/226,688

(22) Filed: Aug. 2, 2016

(51) Int. Cl. A01M 1/04; A01M 1/20; A01M 1/10

(52) U.S. Cl. CPC A01M 1/04; A01M 1/106; A01M 1/2016

(57) ABSTRACT

In an aspect, a pest control system is provided. The pest control system includes a pest confinement chamber for receiving a pest attractant, and a chamber base for supporting the pest confinement chamber. The pest confinement chamber is provided with at least one pest aperture to permit entry of a target pest into the pest confinement chamber. The chamber base includes a housing body containing an illumination assembly for illuminating the pest confinement chamber.

### FIELD

The present disclosure relates generally to pest control systems and more particularly to pest traps that incorporate an attractant.

### BACKGROUND

The enjoyment of any particular environment can be severely hindered by pests such as flying insects. To address the inconvenience and discomfort of having insects invade these spaces, a variety of pest management systems (i.e. pest traps) have been proposed through the years.

In one type of commonly used pest trap, a chemical or biological attractant is used to lure the target pest into a trap enclosure. The attractant may be provided in liquid form, and may further comprise a killing agent. In other forms, the attractant may be incorporated into a sticky glue layer, which entraps the pest upon contact.

Another type of pest trap incorporates light to attract the target pest. Insect light traps are commonly found in commercial applications, for example around food preparation and serving areas. Inset light traps may incorporate secondary capture features such as sticky glue surfaces to enhance the capture efficiency.

For residential use, it is desirable to have a pest trap that incorporates multiple pest attractants into a system that is easy to use, easy to clean, and is generally attractive in form.

### SUMMARY

According to an aspect of the disclosure, provided is a pest control system. The pest control system includes a pest confinement chamber for receiving a pest attractant, and a chamber base for supporting the pest confinement chamber. The pest confinement chamber is provided with at least one pest aperture to permit entry of a target pest into the pest confinement chamber. The chamber base includes a housing body containing an illumination assembly for illuminating the pest confinement chamber.

### BRIEF DESCRIPTION OF THE DRAWINGS

The foregoing and other features and advantages will be apparent from the following description of the disclosure as illustrated in the accompanying drawings. The accompanying drawings, which are incorporated herein and form a part of the specification, further serve to explain the principles of the disclosure and to enable a person skilled in the pertinent art to make and use the disclosure. The drawings are not to scale.

FIG. 1 is a perspective view of the pest control system in accordance with an embodiment of the disclosure.

FIG. 2 is an exploded perspective view of the pest control system according to FIG. 1.

FIG. 3 is a longitudinal sectional view of the pest control system according to FIG. 1.

FIG. 4 is a transverse sectional view of the pest control system according to FIG. 1.

### DETAILED DESCRIPTION

Specific embodiments of the present disclosure are now described with reference to the figures, wherein like reference numbers indicate identical or functionally similar elements. The following detailed description is merely exemplary in nature and is not intended to limit the disclosure or the application and uses of the disclosure. Furthermore, there is no intention to be bound by any expressed or implied theory presented in the preceding technical field, background, brief summary or the following detailed description.

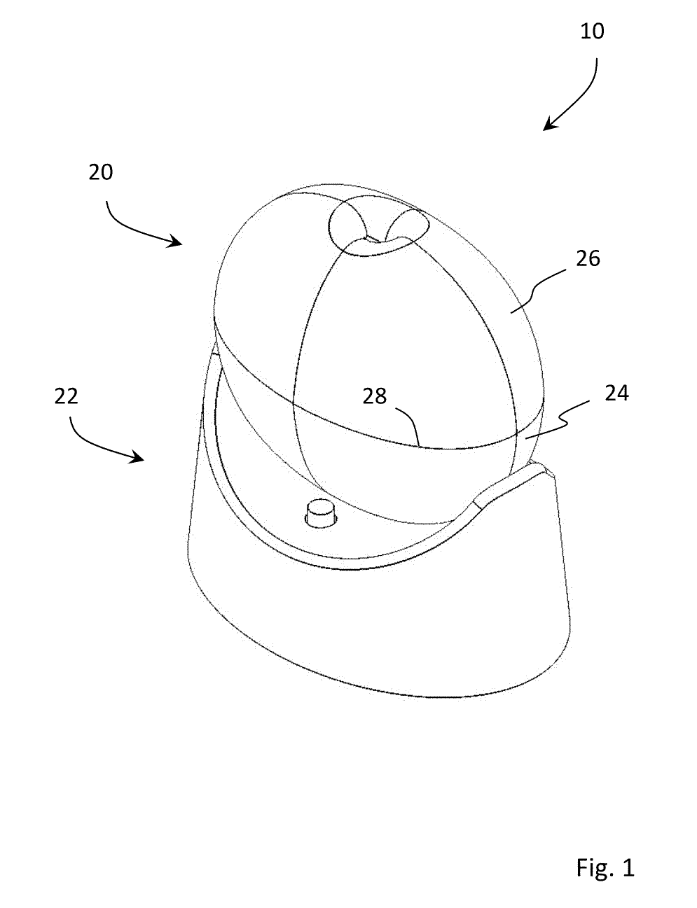

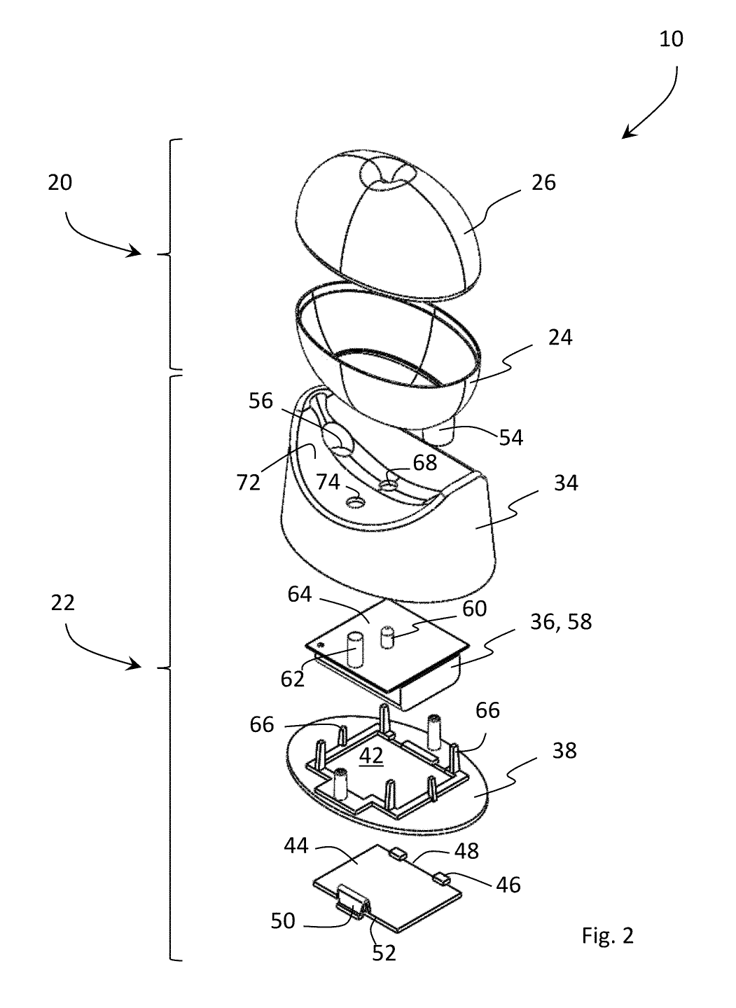

Reference is made to FIGS. 1 and 2, which show a pest control system 10 in accordance with an embodiment of the present disclosure. The pest control system 10 includes a pest confinement chamber 20 and a chamber base 22 for supporting the pest confinement chamber 20 upon a support surface (i.e. a table, not shown).

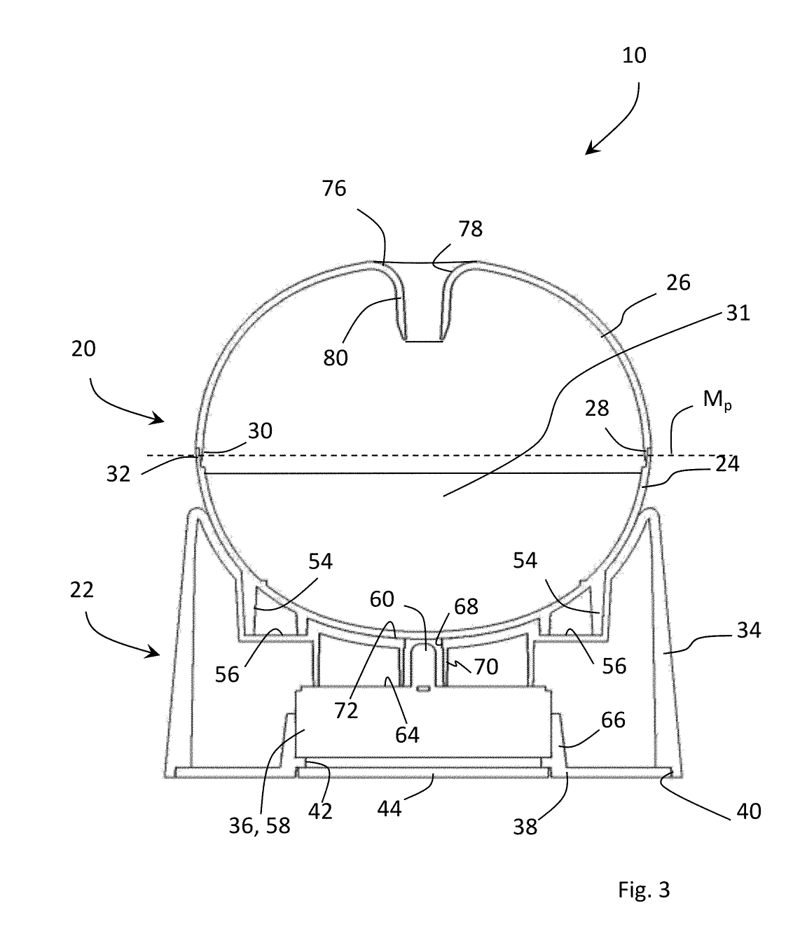

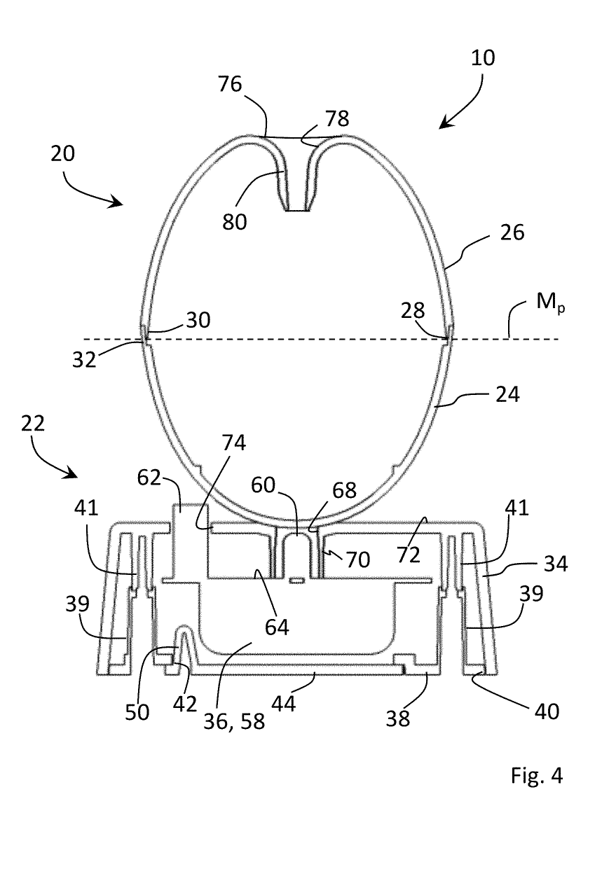

The pest confinement chamber 20 includes a chamber body 24 and a chamber cover 26. The chamber body 24 and chamber cover 26 cooperatively define the overall shape and volume of the pest confinement chamber 20. In the embodiment shown, the pest confinement chamber 20 is generally ellipsoid. The chamber cover 26 is removeably connectable to the chamber body 24 at an interface 28. The interface 28 is located at or proximal a midpoint between the uppermost region and the lowermost region of the pest confinement chamber 20. For the generally ellipsoid-shaped pest confinement chamber 20 of FIG. 1, the interface 28 is at or proximal a plane Mₚ, as shown in FIGS. 3 and 4. Continuing with FIGS. 3 and 4, the chamber cover 26 provides a circumferential flange 30 that cooperates with a circumferential lip 32 provided on the chamber body 24. The circumferential flange 30 of the chamber cover 26 and the circumferential lip 32 of the chamber body 24 are dimensioned to provide an interference fit therebetween, ensuring the chamber cover 26 is securely but removeably connected to the chamber body 24. Removal of the chamber cover 26 from the chamber body 24 facilitates cleaning of the pest confinement chamber 20 after a period of use.

The chamber base 22 is configured to support the pest confinement chamber 20. The chamber base 22 includes a housing body 34, an illumination assembly 36 contained within the housing body 34, and a housing bottom panel 38. As shown in FIGS. 3 and 4, the housing bottom panel 38 is generally sized to fit within a recess 40 provided at the lowermost portion of the housing body 34. Any suitable joining solution may be implemented to retain the housing bottom panel 38 on the housing body 34 including mechanical fasteners (i.e. threaded fasteners) as well as adhesive bonding and welding (i.e. ultrasonic welding). In the embodiment shown, the housing bottom panel 38 provides a plurality of fastener projections 39 that align with a respective fastener post 41 on the housing body 34. The fastener projections 39 are secured to the fastener posts 41 using threaded fasteners (not shown). The housing bottom panel 38 provides a battery access opening 42 and is configured to receive a battery compartment cover 44. The manner of attachment of the battery compartment cover 44 to the housing bottom panel 38 may take on a variety of forms. As shown, the battery compartment cover 44 includes at least one stationary tang 46 at a first end 48, and a deflectably moveable latch 50 at a second end 52. The at least one stationary tang 46 and the deflectably moveable latch 50 are received in suitable receptacles provided on the housing bottom panel 38, as generally known in the art. When the battery compartment cover 44 is attached to the housing bottom panel 38, the battery compartment cover 44 covers the battery access opening 42 and any batteries contained therein as part of the illumination assembly 36.

The housing body 34 provides a support surface 72 that is generally shaped to complement the pest containment chamber 20. In the exemplary embodiment, in a direction bisecting the pest control system 10 through the major axis (i.e. the longitudinal axis) of the pest confinement chamber 20 (as shown in FIG. 3), the support surface 72 of the housing body 34 is provided with a shape that generally matches the elliptical profile of the pest containment chamber 20. In a direction that is transverse to this first direction, that is through the minor axis of the pest confinement chamber 20 (as shown in FIG. 4), the support surface 72 of the housing body 34 is generally planar.

The housing body 34, as well as the housing bottom panel 38 and battery compartment cover 44 may be formed of a suitable polymeric material, including but not limited to, thermoplastics and thermosets. These components may be injection molded, for formed through any alternative process suitable for forming the parts in question.

Mounting of the pest containment chamber 20 upon the chamber base 22, and in particular upon the housing body 34 is facilitated through the use of one or more mating or otherwise cooperating structures provided at the interface therebetween. As shown for example in FIG. 3, the chamber body 24 provides a pair of mount structures 54 that are releasably received by a respective pair of mount receptacles 56 provided on the housing body 34 of the chamber base 22. The mount structures 54 are generally sized relative to the mount receptacles 56 to establish a snug but detachable fit therebetween, enabling detachment of the pest containment chamber 20 from the chamber base 22 when required (i.e. for cleaning).

The illumination assembly 36 is contained within the housing body 34 of the chamber base 22. The illumination assembly includes an assembly housing 58, a light source 60 (e.g. a light-emitting diode (LED)), a power source (e.g. one or more battery units housed within the assembly housing 58) for powering the light source 60, an on/off switch 62 to control delivery of power to the light source 60, and suitable wiring for connecting these components into an operable electronic circuit. The electronic circuitry of the illumination assembly 36 is provided and contained within the assembly housing 58. The light source 60 is arranged in the assembly housing 58 so as to protrude outwardly from an assembly housing surface 64 on the topmost side of the assembly housing 58. Also protruding outwardly from the housing surface 64 is the on/off switch 62.

The housing bottom panel 38 may include a plurality of assembly posts 66 to secure the illumination assembly 36 on the housing bottom panel 38 in a fixed position relative to the battery access opening 42. One or more of the plurality of assembly posts 66 may be configured with suitable features to retain the illumination assembly 36 in the fixed position. For example, the assembly posts 66 may present a mechanical fastener (i.e. tabs, clips, screws, etc.) that engages the illumination assembly 36 to retain it in position. Alternatively, a bonded interface between the assembly posts 66 and the illumination assembly 36 may be established, for example through the use of a suitable adhesive, or by way of welded attachment (i.e. ultrasonic welding).

In the assembled state, the light source 60 of the illumination assembly 36 is positioned proximal a centrally located illumination aperture 68 provided on the housing body 34 of the chamber base 22. As shown in FIG. 3, the housing body 34 provides a light source sleeve 70 for receiving the light source 60 and directing light emitted therefrom towards the illumination aperture 68. To prevent interference with the pest containment chamber 20 supported by the chamber base 22, the light source 60 may protrude partially into but not beyond the illumination aperture 68, that is it does not extend beyond a support surface 72 of the housing body 34 of the chamber base 22.

The on/off switch 62 of the illumination assembly 36 is positioned to protrude through a switch aperture 74 provided on the housing body 34 of the chamber base 22. The on/off switch 62 is accessible to a user of the pest control system 10 to activate the illumination assembly 36. The on/off switch 62 may be provided in the form of a pushbutton switch, but it will be appreciated that other switch types may be suitably implemented.

The chamber cover 26 of the pest confinement chamber 20 is provided with at least one pest aperture to permit target pest entry into the pest confinement chamber 20. As shown, the pest aperture is provided in the form of a centrally located funnel 76 on the uppermost surface of the pest confinement chamber 20. The funnel 76 includes an opening 78 and a collar 80 extending into the pest confinement chamber from the opening 78. As shown, the collar 80 extends at least partially into the interior volume delimited by the chamber cover 28 of the pest confinement chamber 20.

The pest confinement chamber 20 may be formed of any suitable polymeric material, including but not limited to thermoplastic and thermosetting polymers. The chamber body 24 and the chamber cover 26 of the pest confinement chamber 20 may be injection molded, or formed through any suitable alternative molding process to achieve the desired shape. The chamber body 24 and the chamber cover 26 may be formed of either transparent or opaque material. It will be appreciated that the chamber body 24 and the chamber cover 26 need not be formed of the same material. In one embodiment, the chamber cover 26 is formed of a clear material, while the chamber body 24 is formed of an opaque material. In this arrangement, the target pest will be attracted to the light visible through the chamber cover 26 of the pest confinement chamber 20, while the opaque chamber body 24 serves to obscure view of the pest attractant/pesticide and/or the target pests captured therein.

While the pest confinement chamber 20 has been shown to include a pest aperture in the form of the funnel 76, it will be appreciated that in some embodiments, the pest aperture may be presented in a different form. For example, in an alternative embodiment, the pest aperture may be a simple opening, that is without an inner collar. In another embodiment, the pest confinement chamber 20 may present multiple pest apertures. It may also be advantageous in certain embodiments to provide the pest confinement chamber 20 a plurality of differently configured pest apertures. It will be appreciated that different target pests may exhibit different behaviours that necessitate the incorporation of certain features into a pest control system. As such, a range of pest confinement chambers may be manufactured and marketed having specific pest apertures for targeting certain select target pests.

In use, the pest control system 10 provides at least two methods of attraction for the target pests. In a first method, the target pest is attracted to the pest attractant (e.g. chemical attractant, pheromones, etc.) added and contained within the pest confinement chamber 20. The pest attractant may be any suitable solid or liquid attractant, and may also be or contain a substance with insecticidal properties. In some applications, the pest confinement chamber 20 may simply contain water or some other liquid having neither attractant, nor insecticidal properties, but otherwise presents an environment likely to kill the target pests. In a second method, the pest confinement chamber 20 is illuminated by the illumination assembly 36, which serves as an additional attractant for target pests. By forming the pest confinement chamber 20 of a transparent material, target pests, including but not limited to flying insects may be attracted from greater distances to the pest confinement chamber 20. The use of at least these two methods of attraction improves the trapping effect of the pest control system 10.

The target pest itself may be any suitable target pest, such as ants, cockroaches, various types of flying insects, or any other suitable type of pest.

While the light source may be an LED as suggested above, it will be appreciated that other light sources may be used. The illumination assembly 36 may also be configured to present a light source having a desired spectral quality. For example, the illumination assembly may be configured to present a light source that emits a greater proportion of light at the blue end of the visible spectrum.

The pest control system 10 incorporates at least two methods of attracting target pests into an easy to use system. The pest confinement chamber may be provided in a variety of shapes, enabling the system to be produced having regard to both aesthetic and pest attractant/control characteristics. The removable pest confinement chamber enables easy cleaning, making the system suitable for residential use, although the system may be successfully used in commercial applications.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1. A pest control system, comprising:
a pest confinement chamber for receiving a pest attractant;
a chamber base for supporting the pest confinement chamber;
wherein the pest confinement chamber is provided with at least one pest aperture to permit entry of a target pest into the pest confinement chamber; and
wherein the chamber base includes a housing body containing an illumination assembly for illuminating the pest confinement chamber.

2. A pest control system as claimed in claim 1, wherein the pest confinement chamber includes a chamber body and a chamber cover.

3. A pest control system as claimed in claim 2, wherein the chamber body and the chamber cover.

4. A pest control system as claimed in claim 3, wherein the chamber cover is removeably connectable to the chamber body at an interface.

5. A pest control system as claimed in claim 4, wherein the interface is located proximate a midpoint between an uppermost region and a lowermost region of the pest confinement chamber.

6. A pest control system as claimed in claim 1, wherein the chamber body includes at least one mount structure configured to cooperate with a respective mount receptacle provided on the chamber base.

7. A pest control system as claimed in claim 6, wherein the chamber body includes a pair of mount structures, wherein each mount structure is configured to be releasably received by a respective mount receptacle provided on the chamber base.

8. A pest control system as claimed in claim 1, wherein the illumination assembly includes an assembly housing containing a light source, a power source for powering the light source, an on/off switch to control delivery of power to the light source, and wiring interconnected into an operable electronic circuit.

9. A pest control system as claimed in claim 8, wherein the light source of the illumination assembly is positioned proximal a centrally located illumination aperture provided on the housing body of the chamber base.

10. A pest control system as claimed in claim 1, wherein the pest aperture is provided in the form of a funnel having an opening to permit for target pest entry, and a collar extending at least partially into the pest confinement chamber.

11. A pest control system as claimed in claim 10, wherein the funnel is centrally located on an uppermost portion of the pest confinement chamber.

12. A pest control system as claimed in claim 2, wherein the chamber base and the pest confinement chamber are formed of a polymeric material.

13. A pest control system as claimed in claim 12, wherein the chamber cover is formed of a transparent polymeric material while the chamber base and the pest confinement chamber are formed of an opaque polymeric material.

14. A pest control system as claimed in claim 8, wherein the light source is light emitting diode.

15. A pest control system as claimed in claim 8, wherein the light source is configured to emit a greater proportion of light at the blue end of the visible light spectrum.
